(19) United States
(12) Patent Application Publication
(10) Pub. No.: US 2023/0351127 A1
(43) Pub. Date: Nov. 2, 2023

(54) ACCESSORY FOR SMART DEVICE

(71) Applicant: SLASH B SLASH Co., Ltd, Busan (KR)

(72) Inventors: Sun Ho SIN, Sokcho-si (KR); Yong Chae JUNG, Seongnam-si (KR)

(21) Appl. No.: 17/733,964

(22) Filed: Apr. 29, 2022

(51) Int. Cl. G06K 7/10; G06K 19/07

(52) U.S. Cl. CPC G06K 7/10297; G06K 19/0723

(57) ABSTRACT

An accessory for smart device according to an embodiment of the present inventive concept relates to an accessory for a smart device for running a unique content by a smart device of user comprising a NFC tag for performing short-range communication with the NFC reader included in the smart device, wherein: a unique authentication code and an unique content information of the accessory for the smart device are stored in the NFC tag, the smart device activates the unique content based on whether the unique authentication code is registered and the unique content information, when the NFC tag is tagged to the NFC reader, and the activated unique content is run on the smart device.

### TECHNICAL FIELD

The present disclosure relates to an accessory for smart device, and more particularly, to an accessory for smart device capable of running specific content through a smart device equipped with the accessory.

### BACKGROUND ART

With the recent development of communication technology, short-range communication technologies have been introduced and commercialized such as NFC (Near Field Communication), RFID (Radio Frequency IDentification), IRDA (Infrared Data Association), Bluetooth, etc.

Among them, NFC is a non-contact short-range wireless communication technology that enables bidirectional data communication in the 13.56 MHz band at a distance of about 10 cm. Unlike RFID, NFC supports both reading and writing.

It has the characteristic that such NFC can support card emulation, reader mode, and P2P mode, has a recognition time of about 0.1 seconds, has a maximum transmission speed of 424 Kbps, and has high security due to a short communication distance of less than 10 cm, and can associate with various customized services and services.

Services using NFC are widely used and developed in various fields such as education, culture, commerce, learning, broadcasting and security, it is mainly provided in the form of receiving a content corresponding to the NFC code from a content management server and providing it to a user's mobile device.

On the other hand, as the accessory market, such as a case for smart device, has recently grown, an accessory for smart device configured to be linked with a smart device so that a specific content can be run on the smart device has been proposed.

For example, it may be considered that when an NFC tag containing information related to specific content is provided in an accessory for smart device, if the NFC reader of the smart device equipped with the accessory acquires content-related information from the NFC tag attached to the accessory, based on this, the smart device is configured to run the corresponding content.

However, if the accessory for smart device is stolen as described above, there is a problem in that it is vulnerable to security because it can be used in a smart device of another person.

### DISCLOSURE OF INVENTION

### Technical Problem

An object of the accessory for smart device according to an embodiment of the present inventive concept is to provide the following solution in order to solve the problems described above.

It is to provide an accessory for smart device that enables the smart device to run specific content.

In addition, it is to provide an accessory for smart device with improved security so that the run of specific content is possible only in the corresponding smart device.

Objects of the present inventive concept are not limited to those above-mentioned, and other objects not mentioned above will be clearly understood by person having ordinary skill in the art from the following description.

### Technical Solution

An Accessory for smart device according to the present inventive concept relates to an accessory for smart device for running a unique content by a smart device of user, and includes a NFC tag for performing short-range communication with the NFC reader included in the smart device. A unique authentication code and a unique content information of the accessory for the smart device are stored in the NFC tag, the smart device activates the unique content based on whether the unique authentication code is registered and the unique content information, when the NFC tag is tagged to the NFC reader, and the activated unique content is run on the smart device.

The NFC reader acquires the unique authentication code when the NFC tag is tagged in the NFC reader, the smart device is configured to transmit the acquired unique authentication code and a unique ID of the smart device to a content management server, and the content management server is configured to check whether the unique authentication code is registered, and to store the unique authentication code and the unique ID of the smart device matched with each other.

An application for running a unique content corresponding to the unique content information is installed in the smart device, the content management server is configured to check whether the unique ID of the smart device and the unique authentication code are matched each other, and to send a unique content stored in a media sever to the smart device based on the unique content information, when the smart device is accessed in the content management server through the application.

The accessory for smart device further includes a case body composed of a bottom surface and a side surface extending upwardly from the bottom surface. The accessory for the smart device is a case for a smart device configured to accommodate a bottom and a side surface of smart device of user.

The NFC tag is disposed in an area corresponding to the NFC reader of the bottom surface.

The accessory for smart device further includes a film member seated in the receiving area formed on the bottom surface of the case body. The case body is formed of a transparent material.

The NFC tag is disposed in an area corresponding to the smart device of the bottom surface, and a first hollow is formed in an area corresponding to the NFC tag of the film member.

The NFC tag is an accessory for the smart device disposed in an area corresponding to the NFC reader of the film member.

A unique authentication code and a unique content information of the film member are stored in the NFC tag, and a unique authentication code activation server is configured to activate the unique authentication code based on a purchase history of the film member of the user.

### Advantageous Effects

There are advantages that the accessory for smart device according to an embodiment of the present inventive concept includes a CAT (Content Activation Tag) function, which is a solution for activating the content embedded in hardware after confirming personal authentication, so that the accessory for smart device enables the run of a specific content only for a smart device that has been authenticated in advance.

The CAT function is a technology for activating a specific content embedded in an accessory after confirming personal authentication. An NFC tag is embedded in the accessory, and link information for accessing the specific content is stored in the NFC tag.

In particular, it has the effect of providing the technology that when the NFC tag embedded in the accessory is tagged with the NFC reader of the smart device, the smart device checks whether the user has permission to run the specific content specified by the NFC reader and may activate the specific content in the application upon completion of the check.

In addition, accessory for smart device may be provided as a case for smart device, in which case the case body is formed of a transparent material, and by providing a film member having various shapes inside the case body, it can be expected that the user can easily use the case with various shapes and colors.

Effects of the present inventive concept are not limited to those mentioned above, and other effects not mentioned will be clearly understood by person having ordinary skill in the art from the following description.

### BRIEF DESCRIPTION OF THE DRAWINGS

FIGS. 1 and 2 are diagrams illustrating an accessory for smart device according to an embodiment of the present inventive concept.

FIGS. 3 to 5 are diagrams showing various embodiments of accessories for smart device according to another embodiment of the present inventive concept.

FIG. 6 is a diagram schematically illustrating a content providing system including an accessory for smart device according to the present inventive concept.

### DETAILED DESCRIPTION

A preferred embodiment according to the present inventive concept will be described in detail with reference to the accompanying drawings, but the same or similar components are assigned the same reference numerals regardless of reference numerals, and redundant description thereof will be omitted.

In addition, in the description of the present inventive concept, if it is determined that a detailed description of a related known technology may obscure essentials of the present inventive concept, the detailed description thereof will be omitted. In addition, it should be noted that the accompanying drawings are only for easy understanding of the spirit of the present inventive concept, and should not be construed as limiting the spirit of the present inventive concept by the accompanying drawings.

The accessory for smart device according to an embodiment of the present inventive concept is an accessory for smart device that run unique content through the user's smart device 20, and is configured to include a NFC tag 200 performing short-range communication with the NFC reader included in the smart device 20.

Such NFC tag 200 is configured to store a unique authentication code and a unique content information of the accessory for smart device, and to enable run of the unique content information in the smart device 20 after the unique authentication code is activated.

That is, when the NFC tag 200 of the accessory for smart device is tagged to the NFC reader of the smart device 20, the smart device 20 is configured to activate the unique content based on whether the unique authentication code stored in the NFC tag 200 is registered and unique content information, and to run the activated unique content on the smart device 20.

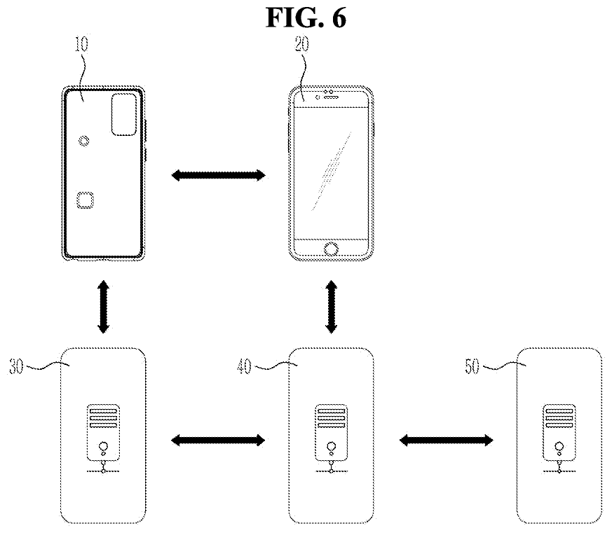

Looking at the above in more detail with reference to FIG. 6, the NFC tag 200 stores a unique authentication code and unique content information of an accessory for smart device, where the unique authentication code is a code for matching the accessory for smart device purchased by the user and the smart device 20 used by the user.

In particular, the unique authentication code is deactivated in normal times, and when the user selects an accessory for smart device in a store and pays at the checkout, the unique authentication code activation server 30 is configured to activate the unique authentication code.

On the other hand, an application for running the unique content corresponding to the unique content information of the NFC tag 200 is installed in the smart device 20, when the user mounts an accessory for smart device in the smart device 20, NFC reader of the smart device 20 acquires a previously activated unique authentication code from the NFC tag 200.

At this time, when the smart device 20 transmits the acquired unique authentication code and the unique ID of the smart device to a content management server 40, the content management server 40 stores the matched unique authentication code and the unique ID of the smart device matched each other.

Afterwards, when the smart device 20 accesses the content management server 40 through the installed application, the content management server 40 checks whether the unique ID of the smart device 20 and the previously activated unique authentication code matches each other, and transmits the specific content stored in the media server 50 to the smart device 20 based on the unique content information.

Therefore, when a third party other than the user mounts the accessory for smart device purchased by the user on his/her smart device, the content management server 40 determines that the activated unique authentication code and the unique ID of the third party's smart device do not match each other, and is configured not to allow access to the content management server of the smart device, and through this, there is an advantage in that it is possible to solve the security problem that cannot be implemented by the conventional NFC way.

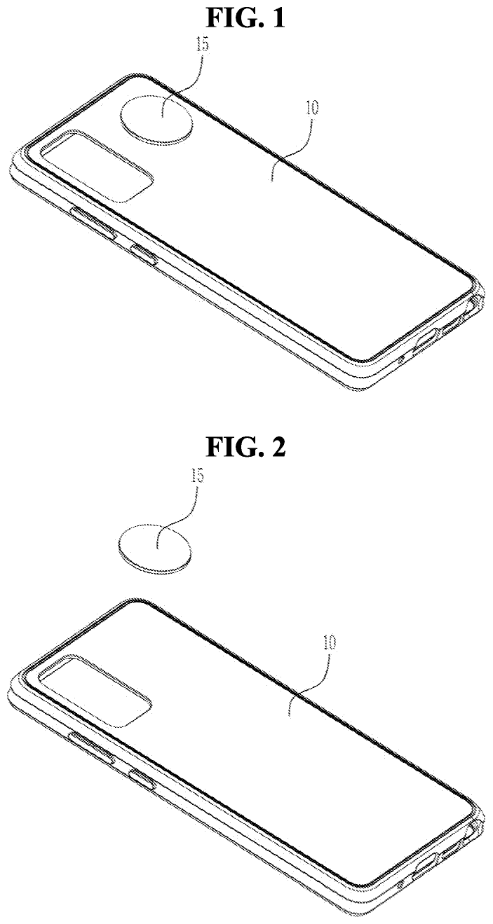

On the other hand, the accessory for smart device according to an embodiment of the present inventive concept may be a cap 15 attached to the smart device 20 or the smart device case 10 as shown in FIGS. 1 and 2, and may be a strap that can ensure one grip or a smart button that performs a separate input function.

In addition, the accessory for smart device according to the present inventive concept is not limited to the aforementioned accessory, and may be various types of accessories capable of NFC communication with the smart device.

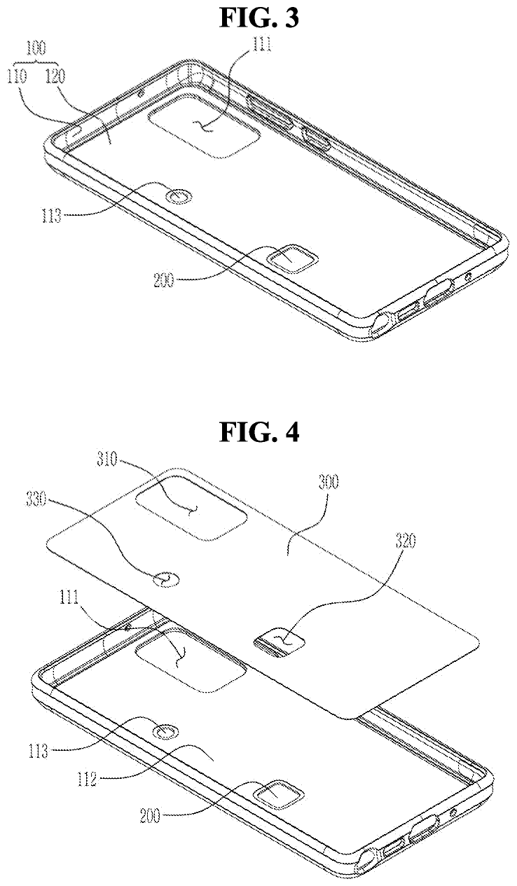

In particular, the accessory for smart device may be configured as a case for smart device. Hereinafter, a case for smart device according to the first embodiment of the present inventive concept will be described with reference to FIGS. 3 to 5.

The case for smart device according to the first embodiment of the present inventive concept relates to a case for smart device configured to accommodate the bottom and side surfaces of the smart device 20, such as a user's smartphone, tablet PC, etc., as shown in FIG. 3, and is configured to include the case body 100 and the NFC tag 200.

The case body 100 is configured to include a bottom surface 110 and a side surface 120, and the bottom surface 110 performs a function of supporting the bottom surface of the smart device 20, and the side surface 120 has a configuration extending upward from the bottom surface 110 and performs a function of enclosing the side of the smart device 20.

On the other hand, since the size of the smart device 20 is different depending on the model, the case for smart device 10 should be formed differently for the bottom surface 110 and the side surface 120 for each model.

In addition, it is preferable that a first camera hole 111 is formed in an area corresponding to the camera position of the smart device 20 of the bottom surface 110 of the case for smart device 10, and openings for external exposure and manipulation of corresponding components are formed in an area corresponding to the connection terminals, microphones, pens, speakers, and side buttons of the smart device 20 of the side surface 120 of the case for smart device 10.

The NFC tag 200 is configured to perform short-range communication with an NFC reader provided in the smart device 20, and in the case for smart device 10 according to the first embodiment of the present inventive concept, the NFC tag 200 is disposed in an area corresponding to the location of the NFC reader of the smart device 20 of the bottom surface 110 of the case body 100.

Hereinafter, the case for smart device 10 according to a second embodiment of the present inventive concept will be described with reference to FIG. 4, in the description of the case for smart device according to the first embodiment of the present inventive concept, a detailed description of the same content as already mentioned will be omitted.

The case for smart device 10 according to the second embodiment of the present inventive concept is configured to include a case body 100, an NFC tag 200 and a film member 300 as shown in FIG. 2.

The case body 100 is formed of a transparent material, and has the above-described bottom surface 110 and side surfaces 120, a receiving area 112 for seating the film member 300 is formed in the bottom surface 110. The receiving area 112 is formed by giving a step in a downward direction with respect to the bottom surface 120 so as to correspond to the size of the film member 300.

Like the case for smart device according to the first embodiment of the present inventive concept, the NFC tag 200 is disposed in an area corresponding to the position of the NFC reader of the smart device 20 of the bottom surface 110 of the case body 100

The film member 300 is configured to be seated in the receiving area 111 formed on the bottom surface of the case body 100 as described above, and may be formed in various colors, and may display various characters and shapes.

That is, since the case body 100 is formed of a transparent material, there is an advantage that the user can use a new case for smart device by replacing only the film member 300 without purchasing the case body 100 anew.

In addition, a second camera hole may be formed in an area corresponding to the camera of the smart device 20 and the first camera hole 111 of the case body 100 of the film member 300, and furthermore, it is preferable that the first hollow 320 is formed in an area corresponding to the NFC tag 200, so as to prevent interference between the NFC tag 200 and the film member 300.

In order to accurately align and seat the film member 300 in the receiving area of the case body 100, a guide part 113 may be formed in the receiving area of the case body 100, and a guide hole 330 may be formed in an area corresponding to the guide portion 113 of the film member 300.

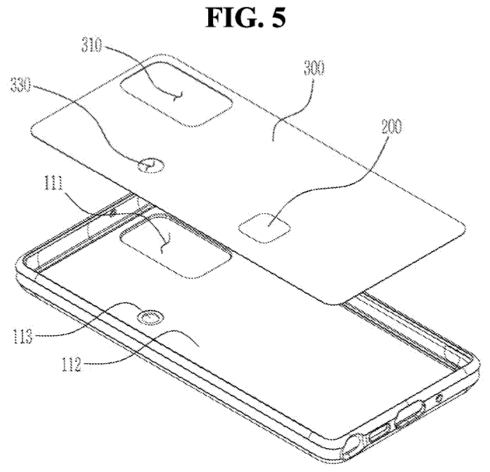

Hereinafter, the case for smart device 10 according to a third embodiment of the present inventive concept will be described with reference to FIG. 5, in the description of the case for smart device according to the first or second embodiment of the present inventive concept, a detailed description of the same content as already mentioned will be omitted.

The case for smart device 10 according to the third embodiment of the present inventive concept is configured to include a case body 100, an NFC tag 200 and a film member 300 as shown in FIG. 5.

In particular, the case for smart device 10 according to the third embodiment of the present inventive concept is different from the case for smart device 10 according to the second embodiment of the present inventive concept in that the NFC tag 200 is disposed on the film member 300 rather than the case body 100.

Specifically, the NFC tag 200 is disposed in an area corresponding to the NFC reader of the smart device 20 of the film member 300, and in this NFC tag 200, the unique authentication code and the unique content information of the film member 300 is stored.

That is, when the user purchases the film member 300 of the case for smart device 10, the unique authentication code of the film member 300 is activated through the CAT (Content Activation Tag) function, and then it is configured to enable run of the unique content information in the smart device 20.

On the other hand, in the case for smart device according to the first embodiment of the present inventive concept, the NFC tag 200 is provided in the case body 100, and in the case for smart device according to the second embodiment of the present inventive concept, the NFC tag 200 is disposed on the film member 300, an embodiment in which the NFC tag 200 is provided on both the case body 100 and the film member 300 can be considered.

For example, the case body 100 has a first NFC tag in which the unique authentication code and unique content information of the case for smart device 10 are stored, and a second NFC tag in which the unique authentication code and the unique content information of the film member 300 is stored may be disposed in the film member 300.

Through this, the smart device 20 can independently run the content for the case for smart device 10 and the content for the film member 200, in this case, there is a problem that smooth communication with the NFC reader of the smart device 20 may not be achieved due to interference between the first NFC tag and the second NFC tag.

In order to prevent this problem, it is preferable that when the film member 300 is not seated in the receiving area 112 of the case body 100, the first NFC tag is activated, and when the film member 300 is seated in the receiving area 112, only the second NFC tag is activated while the first NFC tag is deactivated.

Specifically, the NFC tag is composed of an NFC chip and an NFC antenna, the first NFC tag is disposed in the receiving area 112 of the bottom surface 110, a switching member for controlling the connection of the NFC chip and the NFC antenna of the first NFC tag may be disposed in the receiving area 112.

It is preferable that this switching member is button-type switch such as a dome switch lower than the height between the bottom surface 110 of the case body 100 and the receiving area 112, and if a downward pressure is not applied to the switch, the NFC chip and the NFC antenna of the first NFC tag are electrically connected, and conversely, when a downward pressure is applied to the switch, it can be configured to become the state in which the NFC chip and the NFC antenna of the first NFC tag are not electrically connected.

The embodiments described in this specification and the accompanying drawings are merely illustrative of some of the technical spirit included in the present inventive concept.

Therefore, since the embodiments disclosed in the present specification are for explanation rather than limitation of the technical spirit of the present inventive concept, it is obvious that the scope of the technical spirit of the present inventive concept is not limited by these embodiments. It should be interpreted that modifications and specific embodiments that can be easily inferred by a person having ordinary skill in the art within the scope of the technical spirit included in the specification and drawings of the present inventive concept are included in the scope of the present inventive concept.

1. An Accessory for smart device for running a unique content by a smart device of user comprising:
a NFC tag for performing short-range communication with the NFC reader included in the smart device, wherein:
a unique authentication code and a unique content information of the accessory for the smart device are stored in the NFC tag,
the smart device activates the unique content based on whether the unique authentication code is registered and the unique content information, when the NFC tag is tagged to the NFC reader, and
the activated unique content is run on the smart device.

2. The accessory for smart device of claim 1, wherein:
the NFC reader acquires the unique authentication code when the NFC tag is tagged in the NFC reader,
the smart device is configured to transmit the acquired unique authentication code and a unique ID of the smart device to a content management server, and
the content management server is configured to check whether the unique authentication code is registered, and to store the unique authentication code and the unique ID of the smart device matched with each other.

3. The accessory for smart device of claim 2, wherein:
an application for running a unique content corresponding to the unique content information is installed in the smart device, and
the content management server is configured to check whether the unique ID of the smart device and the unique authentication code are matched each other, and to send a unique content stored in a media sever to the smart device based on the unique content information, when the smart device is accessed in the content management server through the application.

4. The accessory for smart device of claim 1, further comprising a case body composed of a bottom surface and a side surface extending upwardly from the bottom surface,
wherein the accessory for the smart device is a case for a smart device configured to accommodate a bottom and a side surface of smart device of user.

5. The accessory for smart device of claim 4, wherein the NFC tag is disposed in an area corresponding to the NFC reader of the bottom surface.

6. The accessory for smart device of claim 4, further comprising a film member seated in the receiving area formed on the bottom surface of the case body,
wherein the case body is formed of a transparent material.

7. The accessory for smart device of claim 6, wherein:
the NFC tag is disposed in an area corresponding to the smart device of the bottom surface, and
a first hollow is formed in an area corresponding to the NFC tag of the film member.

8. The accessory for smart device of claim 6, wherein the NFC tag is an accessory for the smart device disposed in an area corresponding to the NFC reader of the film member.

9. The accessory for smart device of claim 8, wherein:
a unique authentication code and a unique content information of the film member are stored in the NFC tag, and
a unique authentication code activation server is configured to activate the unique authentication code based on a purchase history of the film member of the user.
